(19) United States
(12) Patent Application Publication
(10) Pub. No.: US 2003/0013072 A1
(43) Pub. Date: Jan. 16, 2003

(54) Processor adjustable exercise apparatus

(76) Inventor: Richard Todd Thomas, Novato, CA (US)

Correspondence Address: Gideon G. Gimlan, Esq., FLIESLER DUBB MEYER & LOVEJOY LLP, Fourth Floor, Four Embarcadero Center, San Francisco, CA, 94111-4156, US

(21) Appl. No.: 10/185,601

(22) Filed: Jun. 27, 2002

Related U.S. Application Data
(63) Continuation-in-part of application No. 09/898,834, filed on Jul. 3, 2001.

(51) Int. Cl. G09B 9/00; G09B 19/00; A63B 69/00

(52) U.S. Cl. 434/247

(57) ABSTRACT

A processor adjustable exercise system includes at least one exercise station having an adjustable and/or configurable user contacting portion and an adjustment mechanism. The exercise mechanism is adapted to enable a user to perform repetitions of an exercising motion. The adjustment mechanism is responsive to a processor, such as a computer, having an associated memory device. Adjustments can be made during exercise, based on physiological information received from sensors associated with a user. The adjustment mechanism is operatively coupled to the adjusting mechanism to effect automatic adjusting and/or configuring of the mechanism upon an identifying of a respective user.

### RELATED APPLICATIONS

This application is a continuation-in-part application claiming priority to U.S. Utility application Ser. No. 09/898,834, incorporated herein fully by reference.

### BACKGROUND

1. Field of the Disclosure

The present invention relates to exercise and athletic training machines. More particularly, the present invention relates to processor or computer controlled exercise apparatus providing automated adjustment and configuration at the time of use in response to information retrieved from a memory device associated with a processor or computer.

2. Background

A large variety of exercise and conditioning apparatus are known in the art. These machines may range from a single exercise device, such as a elliptical trainer or a benchpress machine, to a multi-station apparatus having a plurality of what may be termed ‘training stations’.

When considering training facilities having a number of varied training apparatus, each time an individual moves from one training station to a next, a number of adjustments and settings can be effected. For example, a desired exercise level or an amount of weight to be lifted can be selected. In addition, other physical adjustments or physical parameter settings typically can be applied, including one or more of adjusting seat backs, bench heights, spacings of hand gripping portion or locations, etc. As such, adjusting and configuring of a training station to suit ones individual requirements can be time consuming and tedious. For example, if a number of training stations are to be used, the proper adjusting and configuring of each station, may account for an appreciable amount of available time, especially when one is attempting to fit a training session into a relatively short period of time before or after a work day. However, it can be desirable that such training apparatus be adjusted to accommodate the individual using the apparatus to prevent a possible serious injury, as well as improve the results and gain of a training or workout session.

When considering an individual who has developed and maintains a complicated exercising or training routine, it may be desirable to record the various settings and exercise levels applied to each exercise station, for each exercise session. If done manually, such recording steps can add additional burdens and further increase the time period required to complete an exercise session. In addition, if the recorded information describing the exercise sessions is lost or misplaced, an individual may have to invest a significant effort to re-create and re-record the information.

### SUMMARY

An improved and automated exercise apparatus is disclosed. In particular, an automated and processor or computer controlled apparatus is provided that includes means for identifying a user, and as a result one or more settings and adjustments can be automatically effected. Further, such a system can include means for automated monitoring of exercising sessions and the automatic recording of information obtained by monitoring devices and of progress made by users thereof. Such a system can automatically adjust the equipment so that the exercise levels can be altered during a session, and/or on a session-by-session basis.

The types of exercise equipment to which the adjustment mechanisms can be applied are not limited to a particular type. For example, treadmills, stair climbers, moveable climbing walls, spring or tension-based equipment, isometric trainers, isotonic trainers, weight training equipment, swimming equipment (e.g., pools that provide a flow of water, or current in which a swimmer exercises) and other systems known in the art can be adapted to provide automatic adjustment to suit particular desires of a person using the equipment.

A full understanding of the present disclosure, including an understanding of a number of capabilities, characteristics, and associated novel features, will result from a review of the description and figures of several embodiments provided herein. The drawings and descriptions are illustrative only and are not intended to limit the scope of the disclosure. Variations and alternate embodiments are contemplated as being part of the disclosure.

In accordance with the present disclosure, exercise apparatus is provided with automated setting mechanism, which can adjust the amount of exercise (e.g., resistance or effort used with the training mechanism) needed in response to input from the user. In certain embodiments, the setting mechanism is arranged to enable a user to perform repetitions of an exercising or training motion. The repetitions, which are useful for conditioning one or more muscles of the body of a user, may range from steps on a treadmill, to basic lifting motions, to a variety of ‘crunching’ motions, or other types of exercise with each motion or effort being at least partially regulated by the equipment.

The automated setting mechanism can include a computer or a processor, which, in some embodiments can be provided by a microprocessor or microcontroller-based system, including embedded processors along with an adjustment mechanism. The adjustment mechanism can respond to the computer or processor, and can be further operatively coupled to portions of the exercise mechanism. Such operative coupling can allow automated adjusting and configuring of one or more physical parameters of the exercise apparatus by applying one or more personalized settings associated with a user. For example, an exercise level may be set, a seat back position may be adjusted, the height of a grasping bar (above from a ground surface) may be altered, a pedal location may be changed, etc. Regardless of the particular structure and types of exercise supported by a particular type of exercise apparatus or a station thereof, one or more physical parameters, along with a effort level, will typically require adjusting and configuring the device.

One step carried out by the devices of the present disclosure can include identifying the user who is about to use an exercise station or apparatus. Accordingly, upon commencing activities, a user can be identified, and in further embodiments, the user can authorize access to the apparatus. Identification may be realized by way of a magnetic card reader, a radio frequency device, a bio-reading means, inputting an identification number or other information by way of a key pad, or any other suitable means that would enable the user to be easily, accurately, and rapidly identified prior to commencing activities upon the exercise apparatus. Subsequently, after a user is identified, an authorizing step can be used to block an individual from using the apparatus or station. For example, in a commercial gymnasium or health club environment, a user may be required to receive some instruction or an evaluation before using a more complicated or demanding apparatus.

A setting mechanism can also include means for recalling at least one personalized setting, which has been previously determined for the user, that may be applied for adjusting and configuring an exercise apparatus. This latter means may include the adjustment mechanism, along with interface components necessary or desirable to enable the computer to be in operative communication with the adjustment mechanism.

Therefore, embodiments of the exercise apparatus of the disclosure can be structured for automatically adjusting and configuring various physical parameters to selected settings and values associated with an identified user. Additionally, certain embodiments permit adjustment of exercise level based on information obtained from monitoring devices, such as gas analyzers, that can be used to monitor oxygen consumption, carbon dioxide production, heart rate monitors, and electrocardiograph devices. These settings can typically result in adjusting dimensions, configurations, effort levels, etc., of one or more portions of a exercise mechanism. A change in configuration may also completely alter the type of training activity or exercise that can be performed upon the apparatus.

Adjustments to physical parameters can be realized by actuating one or more adjusting means of an adjustment mechanism. Adjusting means, which may also be termed actuators, can include one or more of solenoids, relays, linear actuators, motors, motorized pinions, and or other devices available to those skilled in the art, or combinations of such devices. Each of these devices may be electrically, hydraulically, or pneumatically actuated or energized.

Other embodiments include systems that may be distributed, computerized, and/or automated. Such systems may have a plurality of stations, and each can be structured to permit a user to perform repetitions of an exercise activity. One or more stations can be provided, having an exercise mechanism in operative communication with a processor or computer for enabling automated adjusting and/or configuring of at least a portion of the mechanism for use by a particular user. In addition, each station can include means for providing personalized settings to be applied to adjust and/or configure the station for use by an identified user. Such a means can include a database and a database management system.

A system having a distributed architecture may couple each station to a remote processor or computing means via suitable hardwired or wireless communication links.

User information, including personalized settings for each training station, may then be centrally located and administered. This arrangement may enable a user to select and use any one of a plurality of identical training stations that are available, and have appropriate settings quickly downloaded and applied.

### BRIEF DESCRIPTION OF THE DRAWINGS

In the drawings, like elements are assigned like reference numerals. The embodiments described herein are not intended to limit the scope of the disclosure. The drawings are briefly described as follows:

FIG. 1 depicts a high-level block diagram of an embodiment of a resistance training apparatus in accordance with the present disclosure.

FIG. 2 depicts a simplified flow-chart of an embodiment of a method employable with the apparatus of FIG. 1 or with FIG. 6.

FIG. 3 depicts a high-level block diagram of an embodiment having a distributed and preferably networked architecture.

FIG. 4 depicts a simplified top-level flow-chart of an embodiment of a method employable with the distributed architecture of FIG. 3 or FIG. 7.

FIGS. 5A and 5B each depict database records available for recalling and applying to adjust and configure a respective exercise station and or apparatus of the disclosure.

FIG. 6 depicts a high-level block diagram of an embodiment of an exercise apparatus in accordance with the present disclosure.

FIG. 7 depicts a high-level block diagram of another embodiment having a distributed networked architecture.

### DETAILED DESCRIPTION

Definitions for a number of terms and expressions that are used throughout this disclosure are provided. The term ‘resistance level’, as applied in the context of the present descriptions, is to be defined broadly. As such, a resistance level includes a force that is applied against a training motion or training activity to increase a level of exertion required by a user. An increase in resistance or resistance level may involve an increase in weights to be lifted, an increase in friction or required torque associated with a training motion.

The term “exercise level” includes the amount of effort needed for a user to use an exercise device. Exercise level includes effort needed to overcome friction, to overcome the force of a spring or tension device, to gain elevation with respect to contact points on an exercise device, and other efforts needed. Exercise level is related to the change in oxygen consumption or carbon dioxide production of a subject using the exercise equipment. Thus, a change in oxygen consumption or carbon dioxide production, compared to the respective resting levels, reflects a change in exercise level. For example, increased oxygen consumption or carbon dioxide production is generally, in steady-state exercise, associated with increased level of exercise.

The term ‘physical parameter’ includes any physical or configuration setting associated with a respective training station or apparatus. Accordingly, a physical parameter setting may include a seat back position setting, a bench height setting, a position setting of at least one hand or foot contacting portion, etc. An ‘exercise level adjustment’ is to be considered an additional item to be applied in addition to any required physical parameter settings. The term ‘exercise activity’ includes all activities used for physical training or exercise purposes. Such activities include ‘resistance training activity,’ ‘isotonic training activity,’ ‘isometric training activity,’ ‘tension training activity,’ and other training, exercise and/or physical conditioning activities. These can include, by way of example only, activities such as running, biking, rowing, stair climbing, weight lifting, and a wide variety of other known exercise, training and workout activities and motions. As such, an exercise activity may involve repetitions of ‘training motions’ with a completion of each full motion termed a ‘repetition’ or ‘rep.’

Information acquired during exercise can be used to adjust the apparatus to produce a desired level of exercise. For example, if a desired percentage of maximum heart rate is desired (maximum heart rate is approximated by 220 beats per minute (bpm)—age in years), then a heart rate monitor can calculate the desired or target heart rate based on the above algorithm, and adjust the exercise apparatus to vary the exercise level necessary to produce in the user that pre-set heart rate. Thus, if a measured heart rate is below the target rate, the apparatus can automatically adjust the exercise level (e.g., increase) to raise heart rate.

Similarly, carbon dioxide production, oxygen consumption, and/or the ratio of carbon dioxide production to oxygen consumption (“respiratory quotient” or “RQ”) can be calculated. During steady-state exercise, the RQ is typically below about 1.0. Thus, RQ can be used as a measure of steady-state exercise. If the measured/calculated RQ is found to be greater than about 1, the exercise is not in a steady-state, but rather is in a non-steady state, that may reflect anerobic metabolism (e.g, not enough oxygen consumption to oxidize lactic acid produced during anerobic metabolism). In such a situation, the exercise level of the apparatus can be automatically adjusted (e.g., reduced) so that RQ returns to a desired level (e.g., below about 1). In other circumstances, it can be desirable to provide periods of anerobic metabolism, for example to promote increased vascularization of exercising muscles. In these situations, periods of anerobic metabolism can be produced by the apparatus increasing the level of exercise to a level that would drive the RQ to above 1, for example, to 1.5 or to 2, 3 or even higher. It can be appreciated that these levels of anerobic exercise may not be sustainable for long periods of time, so the exercise apparatus can be programmed to automatically reduce such high exercise levels to permit the user's RQ to lower to a steady-state range (e.g., at or below about 1).

Additionally, skin resistance measurements can be used to automatically adjust a person's level of exercise. If the level of exercise is low, and a person doesn't sweat, the resistance to electrical currents can be at a relatively high level. However, because sweat has salt ions (e.g., Na and Cl), sweating can decrease measured skin resistance. Thus, exercise apparatus can monitor skin resistance and information so obtained can be used to adjust levels of exercise. It can be appreciated that the above three types of physiological measurements are not exhaustive, and that other variables can be measured during exercise and those measurements, compared with pre-set or calculated desired ranges can be used to adjust the level of exercise in such apparatus.

Once a physiological variable is measured, the data can be imported into a memory device and a processor. The processor can apply an algorithm to the data and produce an output signal that can be exported to the adjustment mechanisms on the exercise apparatus.

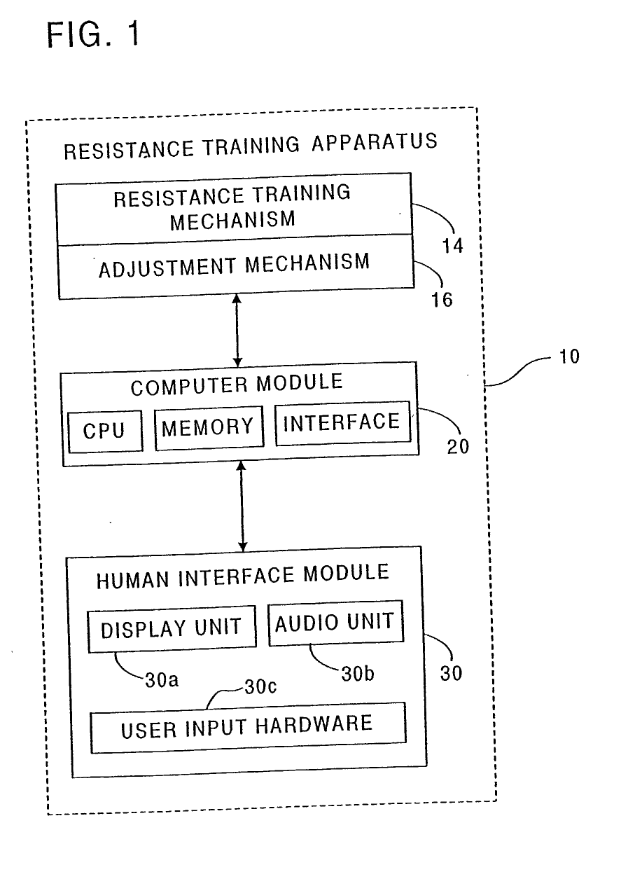

FIG. 1 depicts a high-level block diagram of a computerized resistance training apparatus 10 in accordance with the present disclosure. Resistance training mechanism 14 is operatively coupled to adjustment mechanism 16. Training mechanism 14 is specifically structured for enabling a user to perform repetitions of an exercising or training motion. Each training motion will generally have associated therewith at least one selectable resistance level that is selected to establish a desired level of resistance. For example, an amount of weights to be lifted or a friction setting may be adjusted. Adjustment mechanism 16 includes means for adjusting physical parameters of training apparatus 10. Settings applied to alter the physical parameters can be previously determined and stored in a suitable memory, such as a database. When applied in accordance with the present disclosure, the settings may direct adjustment of one or more user contacting portions of the resistance training mechanism 14 so as to accommodate physical attributes of a user preparing to use apparatus 10.

In certain embodiments, a database may be provided by a computer or computing means of computer module 20. Other embodiments may employ an interface of computer module 20 to enable communication with another remote or discrete computer, with the remote computer including the database of user information from which settings are download. The downloaded settings can then be applied by computer module 20.

To support the automated adjusting and/or configuring of one or more physical parameters of the apparatus 10, adjustment mechanism 16 is operatively coupled to, and responsive to, a computer, such as computing module 20. The computer is further coupled to a human interface 30. Human interface 30 can include user input hardware 30c. User input hardware 30c can enable a user to input information, including information enabling the apparatus to identify the user and access one or more stored data records associated with the user and a selected training apparatus 10.

Display unit 30a and an audio unit 30b may be included to enable an exchanging of information between the user and the apparatus, as required before commencing and completing a training activity. For example, information related to a repetition count setting, a number of repetitions completed or remaining, a resistance level setting, etc., may be delivered by the display unit 30a.

When considering portions of the training apparatus 10 that enable a user to be identified, a plurality of varied structures and approaches may be utilized. For example, simple keypads and user PINS may be used. Alternatively, magnetic card readers, bio-scanning devices, or RF-ID technology may be employed. Regardless of the particular structure and components actually utilized, such portions of the present invention may be generically termed “means to enable a user to be identified”. Such a means may actually employ an exchange between the computing module 20 and other devices or modules for a user identification to be fully realized. Similarly, a combination of portions of the computing module 20, the human interface module 30 and the adjustment mechanism 16 may be termed a “means for enabling at least one personalized setting to be recalled and applied for configuring the resistance training apparatus”. In some embodiments, the personalized settings were previously determined, and are applied upon identifying the user, and possibly subsequently updated as desired.

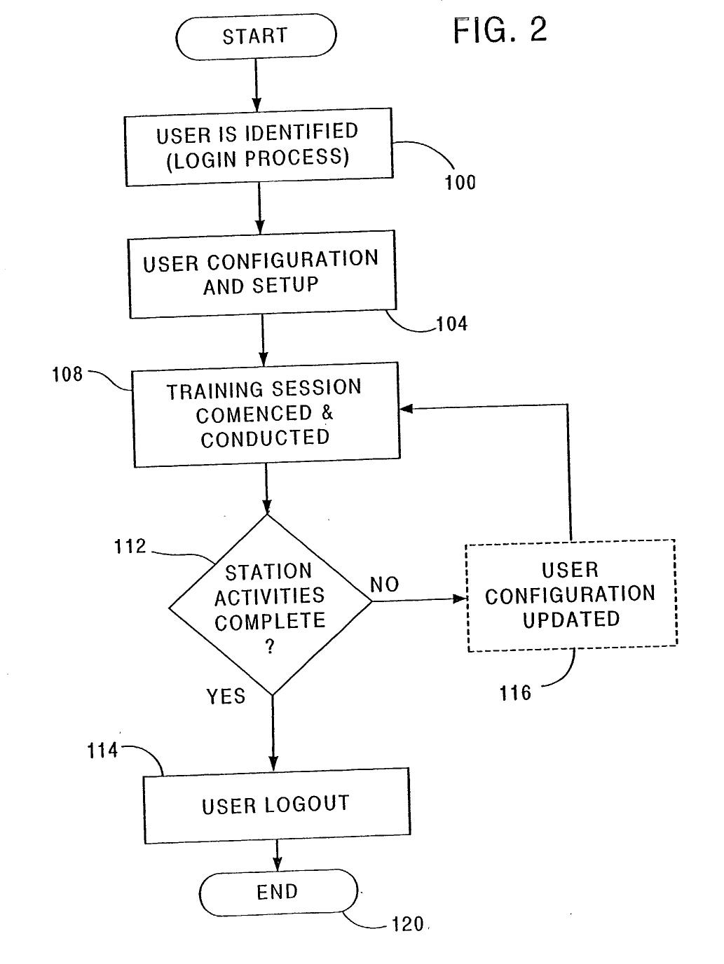

FIG. 2 depicts a simplified flow-chart for an embodiment of a method employable with the apparatus of FIG. 1, and equivalents thereto. The method may commence with a user being identified. The identifying may be by way of a ‘login’ event. For example, the user may input a unique string of characters and possibly a personal identification number (PIN). Once identified at 100, a training apparatus 10 may be automatically configured, adjusted, and setup at 104 for use by the identified user. At 108, a workout or training session is commenced and conducted, resulting in the user performing repetitions of a training activity. At 112, the algorithm may call for an iterative evaluation as to whether all desired or required activities to be conducted upon the present training apparatus 10 have been completed. If so, the user can log out, or can move to another training station, progressing through an established training routine. If activities at a present training station have not been completed, at 116 additional adjusting and configuring may be performed upon the training apparatus 10, and additional exercising or training session activities can be conducted. The additional training session may not require any additional adjusting and configuring, which is indicated by step 116 being provided with a dotted outline.

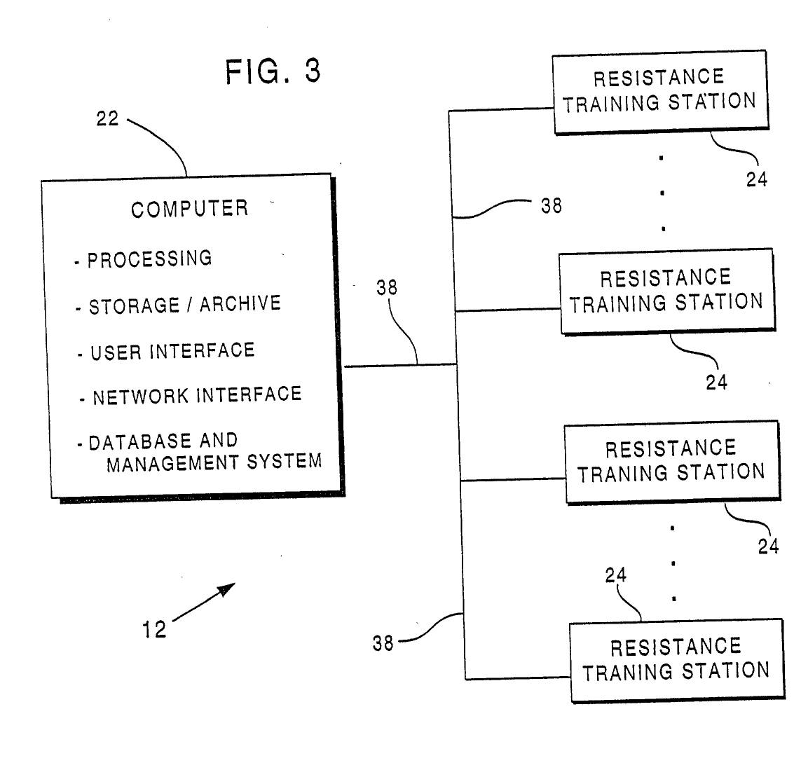

FIG. 3 depicts a high-level block diagram of another embodiment of the disclosure. Training system 12 is provided that may be termed a distributed, computerized, and automated resistance training system. The system 12 includes a plurality of configurable resistance training stations 24 and at least one possibly remote and or discrete computer 22, which is in operative communication with each training station 24. For example, a communication network 38 may be employed to interconnect the computer 22 to each of the resistance training stations 24.

Each training station 24 of the embodiment includes a resistance training mechanism 16 in operative communication with a computer, enabling an adjusting and configuring of a resistance training mechanism 16 as required to accommodate a respective user. Computer 22 may actually exchange information with an embedded computing means provided with each resistance training station 24. Accordingly, the training apparatus 10 of FIG. 1, or variations thereof, may be adapted to function as training stations 24. As discussed above, the actual adjusting and configuring of a respective training station 24 can begin upon or shortly after identifying a user about to use a training station 24. Each resistance training station 24 can include means enabling personalized settings to be applied to adjust and configure one or more physical parameters of the station for use by the user.

In an alternative embodiment of training system 12, computer 22 can include and or have access to a database management system. Computer 22 may be remote or distanced from the training stations 24, yielding a modular and expandable system. Alternately, a multi-station arrangement having a plurality of structurally connected training stations 24 may include computer 22 provided within a suitable portion of such an embodiment.

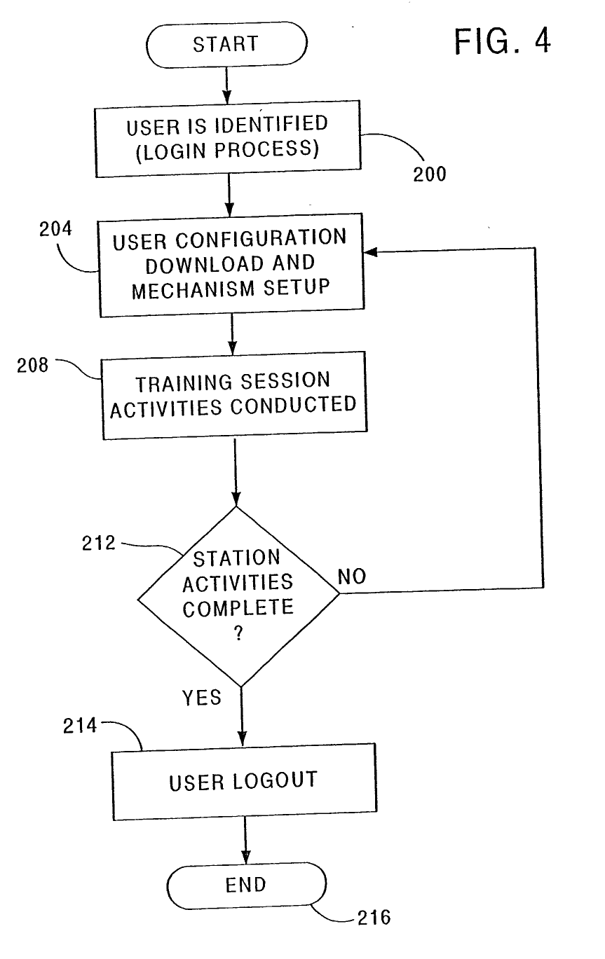

FIG. 4 depicts a method that may be employed with a system as, for example, depicted in FIG. 3. As shown, at 200 a user is identified at a respective training station 24. This may involve a login process, wherein the user provides a user name, or ID number, possibly followed by a password or identification number. Once a user is identified at 200, at 204 one or more records may be automatically accessed for downloading from an available database. The records can include one or more personalized settings, a resistance level setting, and other possible information, each of which may be recalled and downloaded to the resistance training station 24. The downloaded information can then applied to adjust and configure a training station 24.

At 208, a training session is conducted with the user performing training activities via the training station 24. At 212, a determination is made as to whether activities of the user on the present training apparatus are complete. If not, additional information may be downloaded and applied to adjust and/or configure mechanisms of the apparatus at 204, and additional training activities may be conducted at 208. If no additional training activities are required, the user ends the session at the present training station 24. As can be seen at 214, an ending of activities may involve a ‘logging out’ or logout process to be executed. It may be understood that the method of FIG. 4 is one of a number of methods that may be employed with the present invention. For example, a login process at 200 may simply involve a magnetic card being inserted into a suitable magnetic card reading device of the training station 24. Upon identification, a user may use the human interface 30 to select one or more optional settings and adjustments, thereby enabling a user to further define, customize, or alter settings to be used for that training session. Such additional settings and adjustments may be defined once and stored for future use, if desired. If a user has not used a particular apparatus or station before, an initial use may require selecting, inputting, or more generally providing of information to the training system 12 to be stored in a database for future use of that apparatus.

It can be appreciated that the method depicted in the flow chart of FIG. 4 may include additional steps. For example, one additional step may be added to the flow chart of FIG. 4 between 212 and 214. After a training activity being conducted upon a training station 24 is complete, system 12 and training stations thereof may be arranged to upload (to the computer 22), altered and updated personalized settings, which are preferably stored in the database for future use. The altering and updating of one or more settings may be the result of one or more of: 1) completing a predetermined number of repetitions of a given training activity, 2) a number of retrievals of personalized settings from the remote database, 3) user adjustments associated with previous user performed station activities, and 4) calculations based on previously stored personalized settings, along with information associated with previous user performed station activities. However, it can be appreciated that other steps may be added.

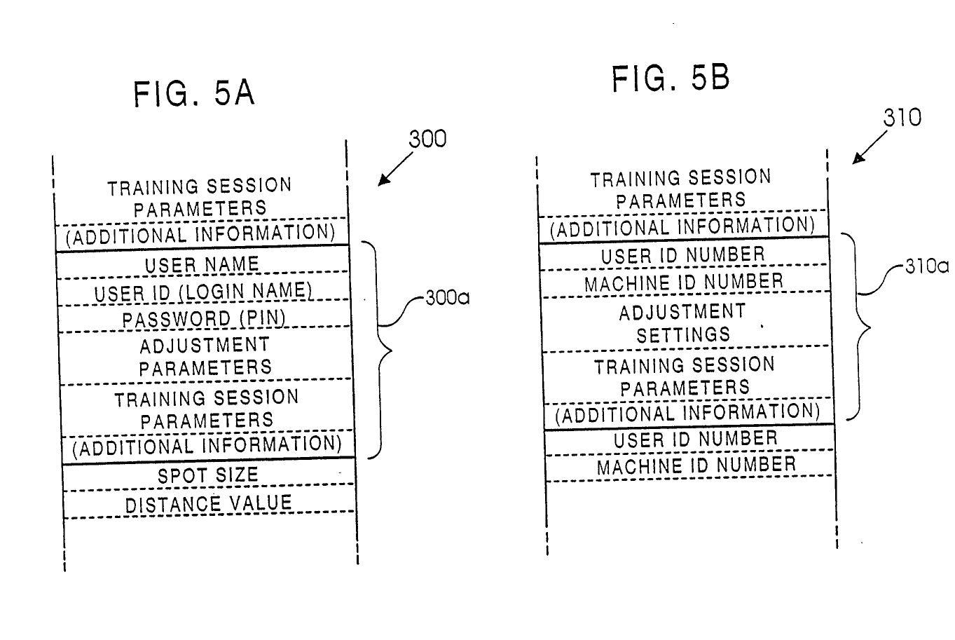

FIGS. 5A and 5B depict two database record formats of this description. In FIG. 5A, one embodiment of record 300a of database 300 is depicted. The record may start with an indication of the full name of a user. Next, a user ID or login name and password may be provided. The user ID and password may be formed of any user preferred string of alphanumeric characters. Record 300a may next provide one or more values or settings associated with physical parameters to be applied to the training apparatus or station to adjust and configure the apparatus. Next, training session parameters, such as a repetition count, resistance settings/levels, time intervals, and other possible parameter settings may be downloaded and utilized. If desired, additional information may also be stored within the accessed record, as needed for supporting the operation of the apparatus and for an updating of present records of the user.

Yet another embodiment of a record format is depicted in FIG. 5B. This format includes user ID information, which may be similar to the user name, user ID, and PIN of FIG. 5A. Next, as can be seen in FIG. 5B, an apparatus type number may be provided to identify which training apparatus the user is about to use. Once a machine ID is matched to a training station to be employed, a plurality of adjusting and configuring settings and session parameters, similar to those of FIG. 5A may be available for accessing, downloading, and applying to the apparatus (or a training station thereof). Database 300, and/or records 300a, may be used for training apparatus 10 of FIG. 1, while, database 310 and/or records 310a may be used with the training system 12 of FIG. 3.

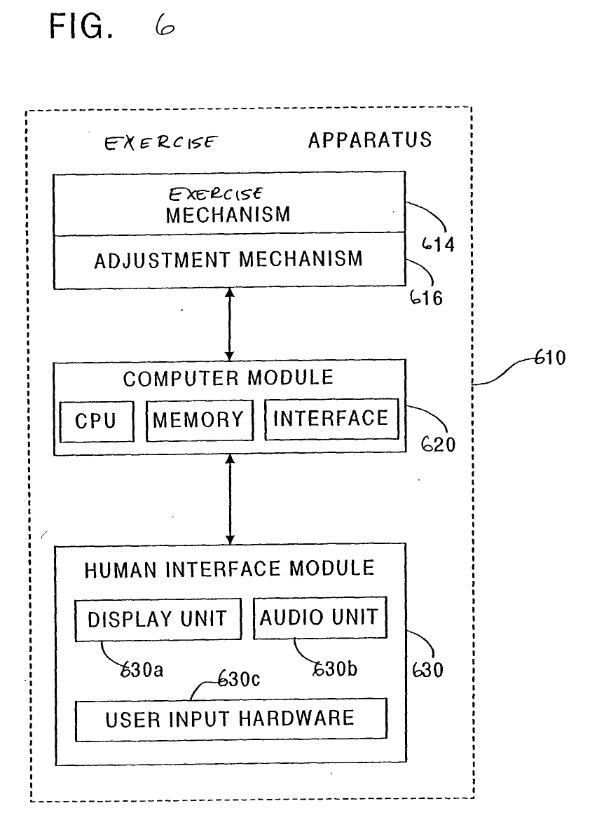

FIG. 6 depicts a high-level block diagram of a computerized exercise apparatus 610 in accordance with the present disclosure. Exercise mechanism 14 is operatively coupled to adjustment mechanism 616. Exercise mechanism 614 is specifically structured for enabling a user to perform repetitions of an exercising or training motion. Each motion will generally have associated therewith at least one desired, selectable resistance level. For example, an amount of weights to be lifted or a friction setting may be adjusted. Adjustment mechanism 616 includes means for adjusting physical parameters of training apparatus 610. Settings applied to alter the physical parameters can be previously determined and stored in a suitable memory, such as a database. When applied in accordance with the present disclosure, the settings may direct adjustment of one or more user contacting portions of the mechanism 614 so as to accommodate physical attributes of a user preparing to use apparatus 610.

In certain embodiments, a database may be provided by a processor, a computer or computing means of computer module 620. Other embodiments may employ an interface of computer module 620 to enable communication with another remote or discrete computer, with the remote computer including the database of user information from which settings are download. The downloaded settings can then be applied by computer module 620.

To support the automated adjusting and/or configuring of one or more physical parameters of the apparatus 610, adjustment mechanism 616 is operatively coupled to, and responsive to, a processor or computer, such as computing module 620. Computer is further coupled to a human interface 630. Human interface 630 can include user input hardware 630c. User input hardware 630c can enable a user to input information, including information enabling the apparatus to identify the user and access one or more stored data records associated with the user and a selected apparatus 610.

Display unit 630a and/or an audio unit 630b may be included to enable an exchanging of information between the user and the apparatus, as desirable before commencing and completing a training activity. For example, information related to a repetition count setting, a number of repetitions completed or remaining, an exercise or resistance level setting, etc., may be delivered by the display unit 630a.

When considering portions of the apparatus 610 that enable a user to be identified, a plurality of varied structures and approaches may be utilized. For example, simple keypads and user PINS may be used. Alternatively, magnetic card readers, bio-scanning devices, or RF-ID technology may be employed. Regardless of the particular structure and components actually utilized, such portions of the present invention may be generically termed “means to enable a user to be identified”. Such a means may actually employ an exchange between the computing module 620 and other devices or modules for a user identification to be fully realized. Similarly, a combination of portions of the computing module 620, the human interface module 630 and the adjustment mechanism 616 may be termed a “means for enabling at least one personalized setting to be recalled and applied for configuring the resistance training apparatus”. In some embodiments, the personalized settings were previously determined, and are applied upon identifying the user, and possibly subsequently updated as desired.

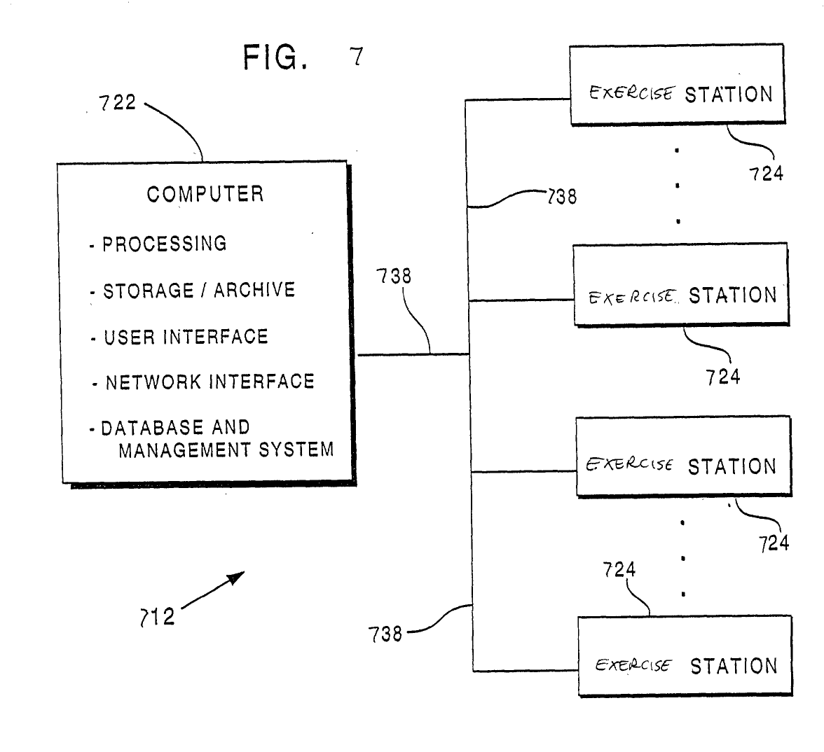

FIG. 7 depicts a high-level block diagram of another embodiment of the disclosure. Exercise system 712 comprises a distributed, computerized, and/or automated exercise system. The system 712 includes a plurality of configurable exercise stations 724 and at least one possibly remote and or discrete processor or computer 722, which is in operative communication with one or more station 724. For example, a communication network 738 may be employed to interconnect the computer 722 to each of the exercise stations 724.

Each station 724 of the embodiment includes a an exercise mechanism 614 as shown in FIG. 6, in operative communication with a computer, enabling an adjusting and configuring of mechanism 616 as required to accommodate a respective user. Computer 722 may actually exchange information with an embedded computing means provided with each station 724. Accordingly, the exercise apparatus 610 of FIG. 6, or variations thereof, may be adapted to function as training stations 724. As discussed above, the actual adjusting and configuring of a station 724 can begin upon or shortly after identifying a user about to use a training station 724. Each station 724 can include means enabling personalized settings to be applied to adjust and configure one or more physical parameters of the station for use by the user.

In an alternative embodiment of training system 712, computer 722 can include and or have access to a database management system. Computer 722 may be remote or distanced from the training stations 724, yielding a modular and expandable system. Alternately, a multi-station arrangement having a plurality of structurally connected training stations 724 may include computer 722 provided within a suitable portion of such an embodiment.

It can be appreciated that the descriptions of the embodiments of the present descriptions are illustrative only, and other arrangements are within the scope of this disclosure. Therefore, while there have been described herein the embodiments of a configurable exercise apparatus, or a distributed embodiment thereof, those skilled in the art can appreciate that other and further modifications may be made without departing from the present disclosure.

### INDUSTRIAL APPLICABILITY

Processor adjustable exercise apparatus is useful at least in health care, physical fitness training, rehabilitation and physical therapy industries.

What is claimed is:

1. An exercise apparatus, comprising:
a processor comprising a memory device having at least one personalized setting;
an adjustment mechanism operable linked to said processor enabling adjusting or configuring said apparatus;
a mechanism for identifying a user of said apparatus; and
a mechanism for retrieving said at least one personalized setting and adjusting or configuring said apparatus based on said at least one personalized setting.

2. The apparatus of claim 1, wherein said at least one personalized setting is recalled from a database and applied by said processor after identifying the user.

3. The apparatus of claim 2, wherein the database is remotely located.

4. The apparatus of claim 1, wherein mechanism for identifying the user includes a human interface.

5. The apparatus of claim 4, wherein said human interface includes at least one of:
a) a keypad;
b) a magnetic card reader;
c) a bio-scanner; and
d) a radio frequency identifier.

6. An exercise apparatus, comprising:
a processor operably linked to a memory device;
an exercise mechanism adapted to enable a user to perform repetitions of an exercise activity of a defined intensity, said intensity being defined by a personalized setting of the user, said exercise mechanism further adapted for adjusting user contacting portions of said exercise mechanism; and
an adjusting mechanism responsive to said processor, and structured for adjusting one of adjusting or configuring at least one portion of said exercise apparatus by applying at least one personalized setting retrieved from said memory device, said personalized setting associated with an identified user.

7. The apparatus of claim 6, further comprising:
a) means an identifying a user;
b) means for downloading said at least one personalized setting associated with said user; and
c) means for automatically applying said at least one personalized setting to adjust or configure said apparatus.

8. The apparatus of claim 7, further comprising a mechanism for determining if the user is authorized to use said apparatus.

9. The apparatus of claim 7, wherein said means for automatically applying includes at least one device, responsive to said processor selected from the group consisting of:
a motorized actuator;
a linear actuator; and
a solenoid actuator.

10. An exercise system comprising:
a processor associated with a memory device;
a plurality of exercise stations, each of said stations having user contacting portions adapted to permit a user to perform exercise, at least one of said stations operatively linked to said processor for enabling adjusting or configuring said exercise mechanism for use by an identified user, and at least one of said stations including means enabling personalized settings of an identified user to be applied for adjusting and/or configuring said station.

11. The system of claim 10, wherein the means enabling personalized settings comprises:
a human interface for identifying a user;
an adjustment mechanism responsive to said processor and adapted for adjusting at least one portion of the system by applying at least one personalized setting associated with an identified user; and
a database associated with said memory device for selecting, retrieving and downloading said at least one personalized setting.

12. The system of claim 11, wherein said processor and database are remote, with at least one of said exercise stations further including a communications interface enabling the personalized setting to be downloaded from the database to a training station that is going to be used by the user.

13. The system of claim 12, wherein said at least one personalized setting is selected from the group consisting of:
settings to adjust physical dimensions of user contacting portions of the exercise mechanism;
at least one exercise level setting; and
a repetition count setting.

14. The system of claim 13, wherein said at least one personalized setting is updated and stored in the memory device, as a result of at least one of:
a completing a pre-determined number of repetitions of a given activity;
a threshold number of retrievals of personalized settings from the remote database;
adjustments associated with previous user performed station activities; and
calculations based on at least one previously stored personalized setting; and
information associated with previous user performed station activities.

15. A method for adjusting or configuring an exercise apparatus, comprising the steps of:
a) identifying a user;
b) accessing and downloading from a memory device, at least one personal setting; and
c) applying said at least one personal setting to adjust and/or configure user contacting portions of the apparatus.

16. The method of claim 15, wherein the step of identifying the user includes a login process.

17. The method of claim 16, wherein the memory device is remote.

18. The method of claim 17, wherein said memory device is accessed by way of an interface and a communication network.

19. An exercise apparatus, comprising:
a memory device;
a processor; and
an automatic adjustment mechanism to configure at least one personalized setting of said apparatus.

20. The apparatus of claim 19, wherein said exercise is selected from the group consisting of running, isometric exercise, isotonic exercise, stair climbing and swimming.

21. The apparatus of claim 19, further comprising a physiological sensor.

22. The apparatus of claim 21, wherein said processor produces an output signal exported to sand adjustment mechanism based upon information received from said physiological sensor.

23. The method of claim 15, wherein said personal setting is determined by comparing a desired physiological variable with a physiological variable obtained during exercise.
